(19) United States
(12) Patent Application Publication
(10) Pub. No.: US 2024/0186488 A1
(43) Pub. Date: Jun. 6, 2024

(54) COATING FOR LITHIUM-MANGANESE-NICKEL OXIDE SPINEL

(71) Applicant: SAFT, Levallois-Perret (FR)

(72) Inventors: Benoit MORTEMARD DE BOISSE, BORDEAUX (FR); Valérie DILLAY, LUDON MEDOC (FR); Michel ULLDEMOLINS, BORDEAUX (FR)

(73) Assignee: SAFT, Levallois-Perret (FR)

(21) Appl. No.: 18/285,443

(22) PCT Filed: Mar. 28, 2022
(86) PCT No.: PCT/EP2022/058135

§ 371 Date: Oct. 3, 2023

(30) Foreign Application Priority Data
Apr. 9, 2021 (FR) FR2103677

(51) Int. Cl. H01M 4/36; C01G 53/00; H01M 4/04; H01M 4/131; H01M 4/1391; H01M 4/485; H01M 4/505; H01M 4/525; H01M 10/0525

(52) U.S. Cl. CPC H01M 4/366; C01G 53/54; H01M 4/0404; H01M 4/131; H01M 4/1391; H01M 4/485; H01M 4/505; H01M 4/525; H01M 10/0525; C01P 2002/52; C01P 2004/84; C01P 2006/40

(57) ABSTRACT

A compound of formula LiₓMn_{2-y-z}Ni_{y}MO_{4-d-c}F_{c} (LMNO) where M is one or more elements chosen from the group consisting of B, Mg, Al, Si, Ca, Ti, V, Cr, Fe, Co, Cu, Zn, Y, Zr, Nb, Ru, W and Mo; and 1≤x≤1.4; 0<y≤0.6; 0≤z≤0.2; 0≤d≤1; 0≤c≤1 and the surface of which is at least partially covered with a coating of an oxide or of a lithium oxide. The oxygen of the oxide is partially substituted with fluorine. In the lithium oxide, either the lithium is partially substituted with Na, K or Mg, or the oxygen is partially substituted with fluorine, or the lithium is partially substituted with Na, K or Mg, and the oxygen is partially substituted with fluorine. The creation of the coating makes it possible to reduce the affinity of the LMNO compound for water.

### TECHNICAL FIELD OF THE INVENTION

The technical field to which the invention relates is that of cathodes based on lithium-manganese-nickel oxide spinel, intended for use in lithium-ion electrochemical cells. It also relates to methods for manufacturing such cathodes.

### BACKGROUND OF THE INVENTION

Lithium-manganese-nickel oxides of formula LiMn_{2-y}Ni_{y}O₄ with 0<y<1, abbreviated LMNO in the following, of spinel-type crystallographic structure, are used as cathodic active material of electrochemical cells (cells) of the lithium-ion type. They are characterized by a partial substitution of manganese by nickel. They operate at a high potential of 4.7 V compared to lithium metal and have a specific capacity of around 145 mAh·g⁻¹. The substitution of part of the manganese by nickel makes it possible to reduce the rate of dissolution of the manganese in the electrolyte of the cell in comparison with the spinel LiMn₂O₄. Due to their high operating potential and a lower dissolution rate of manganese in the electrolyte than for the spinel LiMn₂O₄, the LiMn_{2-y}Ni_{y}O₄ oxides constitute a family of compounds which show promise as cathode active materials of lithium-ion type cells. Furthermore, they are more thermally stable than lamellar nickel oxides. Their use therefore makes it possible to increase the safety of use of lithium-ion cell.

However, obtaining a cathode based on a lithium-manganese-nickel oxide spinel is accompanied by several difficulties which hinder its manufacture on an industrial scale. Indeed, to obtain a cathode based on LMNO, it is customary to prepare an ink comprising LMNO. This ink is obtained by dispersing the LNMO and at least one compound that is a good electronic conductor in a solution consisting of an organic solvent in which one or more binders is/are dissolved. However, the organic solvents used are generally expensive and toxic for the operator who handles them. Mention may be made, as frequently used organic solvent, of N-methyl-2-pyrrolidine (NMP). The use of an organic solvent also limits the nature of the binder to a binder compatible with the organic solvent. Mention may be made of polyvinylidene fluoride. It has therefore been sought to replace the organic solvent with an aqueous solvent. Inks based on an aqueous solvent could be obtained. However, it is necessary to eliminate any trace of water present in the ink before mounting the cathode in the lithium-ion cell. Any trace of water present in the electrolyte of the cell is capable of decomposing during the operation of the cell. The presence of traces of water affects the stability of the electrolyte and the integrity of the cathode. The elimination of traces of water makes it necessary to subject the electrode to a drying step which is long and which slows down the cathode manufacturing method. Therefore, a way to manufacture an aqueous ink based on LMNO, which, after drying, has the lowest possible water content, so as to shorten the drying time of the electrode and to reduce the instability of the electrolyte during cell cycling, is sought.

### SUMMARY OF THE INVENTION

To this end, the invention provides a compound of formula LiₓMn_{2-y-z}Ni_{y}M_{z}O_{4-d-c}F_{c} (LMNO) where M is one or more elements chosen from the group consisting of B, Mg, Al, Si, Ca, Ti, V, Cr, Fe, Co, Cu, Zn, Y, Zr, Nb, Ru, W and Mo; and 1≤x≤1.4; 0<y≤0.6; 0≤z≤0.2; 0≤d≤1; 0≤c≤1, the surface of which is at least partially covered with a coating of a second compound chosen from the group consisting of:
a) Liₓ₋ₐM′ₐSi_{y-b}M″_{b}O_{x/2+2y-c-d}F_{c} with 0≤x≤5; 0≤a≤2; 0≤y≤5; 0≤b<y; 0≤c≤2; 0≤d≤2 where M′ is one or more elements chosen from the group consisting of Na, Mg and K;
M″ is one or more elements chosen from the group consisting of B, Mo, Mn, Ce, Sn, Zr, W, V, Ta, Sb, Nb, Ru, Ag, Fe, Co, Ni, Zn, Al, Cr, La, Pr, Bi, Sc, Sm, Gd, Y and Eu;
a and c not being simultaneously zero;
b) Liₓ₋ₐM′ₐNb_{y}Sn_{z}M″_{b}O_{x/2+5y/2+2z-c-d}F_{c} with 0≤x≤3; 0≤a≤3; 0≤y≤1; 0≤z≤1; 0≤b<y+z; 0≤c≤2; 0≤d≤1; b+y+z=1 where
M′ is one or more elements chosen from the group consisting of Na, Mg and K;
M″ is one or more elements chosen from the group consisting of B, Mo, Mn, Ce, Zr, Si, W, V, Ta, Sb, Ru, Ag, Fe, Co, Ni, Zn, Al, Cr, La, Pr, Bi, Sc, Sm, Gd, Y and Eu;
a and c not being simultaneously zero;
c) Nb_{2-b}M″_{b}O_{5-c-d}F with 0≤b<2; 0<c≤2.5; 0≤d≤2 where
M″ is one or more elements chosen from the group consisting of B, Mo, Mn, Ce, Sn, Zr, Si, W, V, Ta, Sb, Ru, Ag, Fe, Co, Ni, Zn, Al, Cr, La, Pr, Bi, Sc, Sm, Gd, Y and Eu;
d) Liₓ₋ₐM′ₐAl_{2-b}M″_{b}O_{x/2+3-c-d}F_{c} with 0≤x≤3, 0≤a≤1; 0≤b≤2; 0≤c≤2.5; 0≤d≤2 where M′ is one or more elements chosen from the group consisting of Na, Mg and K;
M″ is one or more elements chosen from the group consisting of B, Mo, Mn, Ce, Sn, Zr, Si, W, V, Ta, Sb, Nb, Ru, Ag, Fe, Co, Ni, Zn, Cr, La, Pr, Bi, Sc, Sm, Gd, Y and Eu;
a and c not being simultaneously zero;
e) Zr_{1-b}M″_{b}O_{2-c-d}F_{c} with 0≤b<1; 0<c≤1; 0≤d≤1 and M″ is one or more elements chosen from the group consisting of B, Mo, Mn, Ce, Sn, Si, W, V, Ta, Sb, Nb, Ru, Ag, Fe, Co, Ni, Zn, Al, Cr, La, Pr, Bi, Sc, Sm, Gd, Y and Eu; and
f) Liₓ₋ₐM′ₐTi_{y-b}M″_{b}O_{4-c-d}F_{c} in which 0<x≤3; 0≤a≤1; 1≤y≤2.5; 0≤b≤1; 0≤c≤2 and −2.5≤d≤2.5; a and c not being simultaneously zero;
M′ is one or more elements chosen from the group consisting of Na, Mg and K;
M″ is one or more elements chosen from the group consisting of B, Mo, Mn, Ce, Sn, Zr, Si, W, V, Ta, Sb, Nb, Ru, Ag, Fe, Co, Ni, Zn, Al, Cr, La, Pr, Bi, Sc, Sm, Gd, Y and Eu.

In compounds a) to f), the stoichiometric index “d” refers to a possible oxygen deficiency.

The invention is based on the discovery that the application of a coating consisting of certain oxides around the lithium-manganese-nickel oxide LMNO particles makes it possible to reduce the affinity of these particles for water. LMNO particles coated with this coating have a lower amount of residual water than the same LMNO particles without this coating would have. The invention makes it possible to improve the stability of the electrolyte. It also makes it possible to improve the adhesion of the ink to the current collector support of the cathode.

According to one embodiment, in the compound of formula f)

Liₓ₋ₐM′ₐTi_{y-b}M″_{b} O_{4-c-d}F_{c}; x=4/3; 0≤a≤1; y=5/3; b=0; 0≤c≤2 and d=0; a and c not being simultaneously zero. In this embodiment, it is possible to have 0<a≤0.2 and c=0. In this embodiment, it is also possible to have a=0 and 0<c≤0.2. In this embodiment, it is also possible to have 0<a≤0.01 and 0<c≤0.1.

According to one embodiment, 1≤x≤1.4; 0<y≤0.6; z=0 and d=0 in the formula LiₓMn_{2-y-z}Ni_{y}M_{z}O_{4-d} (LMNO).

An object of the invention is also an electrode comprising the compound as described above and a binder dispersible in an aqueous medium. It also relates to an electrode comprising the compound as described above and a current collector support.

An object of the invention is also a lithium-ion electrochemical cell comprising at least one cathode which is the electrode described above.

Finally, the object of the invention is a method for preparing the compound as described above, when the second compound has the formula Liₓ₋ₐM′ₐTi_{y-b}M″_{b}O_{4-c-d}F_{c}. This method comprises the steps of:
a) providing an organic or aqueous solution containing titanium ions;
b) dissolving in the solution of step a) a lithium salt or an organic compound containing lithium and at least one doping compound chosen from the group consisting of a sodium salt, an organic compound containing sodium, a potassium salt, an organic compound containing potassium, a magnesium salt, an organic compound containing magnesium, a fluorine salt, and an organic compound containing fluorine;
c) dispersing a powder of the compound of formula LiₓN_{2-y-z}Ni_{y}M_{z}O_{4-d} in the solution of step b);
d) drying the dispersion to obtain particles of the compound of formula LiₓMn_{2-y-z}Ni_{y}M_{z}O_{4-d} at least partially coated with the lithium salt or the organic compound containing lithium, a titanium compound and said at least one doping compound of step b);
e) heat treating the particles of step d) to obtain a coating of the second compound of formula Liₓ₋ₐM′ₐTi_{y-b}M″_{b}O_{4-c-d}F_{c}.

The electrode as described above can be manufactured using a method comprising the steps of
a) dispersing at least one binder in water;
b) dispersing the compound in the dispersion of step a);
c) optionally adding an electronically conductive compound to obtain an ink, steps b) and c) possibly being reversed;
d) depositing the ink on a current collector support to form an electrode;
b) drying the electrode.

### DESCRIPTION OF EMBODIMENTS OF THE INVENTION

The invention is based on the discovery that the application of a coating consisting of certain oxides around the lithium-manganese-nickel oxide LMNO particles makes it possible to reduce the affinity of these particles for water. These particular oxides a) to f) are detailed in the following.

The oxides a), b), d) and f) are lithiated and have a partial substitution of lithium by the element M′ and/or a partial substitution of oxygen by fluorine.

Oxides c) and e) have a partial substitution of oxygen by fluorine.

The decrease in the affinity of LMNO oxide for water would be improved by the partial substitution either of oxygen by F, or of lithium by Na, K or Mg, or by the partial substitution of oxygen and lithium.

Oxides a) of Formula Liₓ₋ₐM′ₐSi_{y-b}M″_{b}O_{x/2+2y-c-d}F_{c}:

Preferred compounds corresponding to the general oxide formula a) are:
Li₂₋ₐM′ₐSi_{1-b}M″_{b}O_{3-c}F_{c}; 0≤a<2; 0≤b<1; 0≤c≤2, typically Li₂SiO₃ derivatives in which Li is partially substituted with M′ and/or O is partially substituted with F, Si possibly being partially substituted with M″;
Li₄₋ₐM′ₐSi_{1-b}M″O_{4-c}F_{c}; 0≤a≤2; 0≤b<1; 0≤c≤2, typically Li₄SiO₄ derivatives in which Li is partially substituted with M′ and/or O is partially substituted with F, Si possibly being partially substituted with M″;
Si_{1-b}M″_{b}O_{2-c}F_{c}, 0≤b<1; 0<c<2, typically SiO₂ derivatives in which O is partially substituted with F, Si possibly being partially substituted with M″.
   Oxides b) of Formula Liₓ₋ₐM′ₐNb_{y}Sn_{z}M″_{b}O_{x/2+5y/2+2z-c-d}F_{c}:

Preferred compounds corresponding to the general oxide formula b) are:
Nb_{y}M″_{b}O_{5y/2-c}F_{c}, 0≤y≤1; 0≤b<1; 0≤c≤2, typically Nb₂O₅ derivatives (NbO_{5/2}) in which O is partially substituted with F, Nb possibly being partially substituted with M″
Li₁₋ₐM′ₐNbM″_{b}O_{3-c}F_{c}, 0≤a<1; 0≤b<1; 0≤c≤2; typically LiNbO₃ derivatives in which Li is partially substituted with M′ and/or O is partially substituted with F, Nb possibly being partially substituted with M″;
Li₂₋ₐM′ₐSnM″_{b}O_{3-c}F_{c}, 0≤a<2; 0≤b<1; 0≤c≤2; typically Li₂SnO₃ derivatives in which Li is partially substituted with M′ and/or O is partially substituted with F, Sn possibly being partially substituted with M″.
   Oxides c) of Formula Nb_{2-b}M″_{b}O_{5-c-d}F_{c}:

A preferred compound corresponding to the general oxide formula c) is Nb₂O_{5-c}F_{c} where 0<c≤2.5.

Oxides d) of Formula Liₓ₋ₐM′ₐA_{2-b}M″_{b}O_{x/2+3-c-d}F_{c}:

Preferred compounds corresponding to the general oxide formula d) are:
Li₂₋ₐM′ₐAl_{2-b}M″_{b}O_{4-c}F_{c}, with 0≤a≤1; 0≤b<2; 0≤c≤2.5 typically LiAlO₂ derivatives (Li₂Al₂O₄) in which Li is partially substituted with M′ and/or O is partially substituted with F, Al possibly being partially substituted with M″;
Al_{2-b}M″_{b}O_{3-c}F_{c}; 0≤b<2; 0<c≤2.5; typically Al₂O₃ derivatives in which O is partially substituted with F, Al possibly being partially substituted with M″.
   Oxides e) of Formula Zr_{1-b}M″_{b}O_{2-c-d}F_{c}:

Preferred compounds corresponding to the general oxide formula e) are:
Zr_{1-b}M″_{b}O_{2-c}F_{c}; 0≤b<1; 0<c≤1; typically ZrO₂ derivatives in which O is partially substituted with F, Zr possibly being partially substituted with M″.
   Oxides f) of Formula Liₓ₋ₐM′ₐTi_{y-b}M″_{b}O_{4-c-d}F_{c}:

Preferred compounds corresponding to the general oxide formula f) are the Li₄Ti₅O₁₂ derivatives (Li_{4/3}Ti_{5/3}O₄) in which Li is partially substituted with M′ and/or O is partially substituted with F; Ti possibly being partially substituted with M″.

According to one embodiment x=4/3; y=5/3; a=0; b=0; 0<c≤0.2 or 0<c≤0.1 or 0<c≤0.07; and d=0, that is to say compounds of formula Li_{4/3}Ti_{5/3}O_{4-c}F_{c} (Li₄Ti₅O_{3(4-c)}F_{3c}), for example Li_{4/3}Ti_{5/3}O_{3.942}F_{0.058} (Li₄Ti₅O_{11.8255}F_{0.175}).

According to one embodiment x=4/3; y=5/3; 0<a≤0.01 or 0<a≤0.007; b=0; c=0; d=0, that is to say compounds of formula Li_{4/3-a}M′ₐTi_{5/3}O₄ (Li₄₋₃ₐM′₃ₐTi₅O₁₂) where M′ represents one or more elements chosen from Na, K, Mg. M′ can represent the association of Na with K. For example, Li_{4/3-0.006}Na_{0.003}K_{0.003} Ti_{5/3}O₄ (Li_{3.98}Na_{0.01}K_{0.01}Ti₅O₁₂).

According to one embodiment x=4/3; y=5/3; 0<a≤0.01 or 0<a≤0.007; b=0; 0<c≤0.2 or 0<c≤0.1 or 0<c≤0.07 and d=0, that is to say the compounds Li_{4/3-a}M′ₐTi_{5/3}O_{4-c}F_{c} (Li₄₋₃ₐM′₃ₐTi₅O_{3(4-c)}F_{3c}) where M′ is one or more elements chosen from Na, K and Mg. For example, Li_{4/3-0.006}Na_{0.003}K_{0.003}Ti_{5/3}O_{3.942}F_{0.058} (Li_{3.98}Na_{0.01}K_{0.01}Ti₅O_{11.8255}F_{0.175}).

The coating around the LMNO particles generally has a thickness less than or equal to 20 nm. The coating can partially or completely cover the surface of the LMNO particles. The mass of the coating may be 5% or less or 2% or less of the mass of the particle it covers.

The lithium-manganese-nickel oxide spinel coated with one of the oxides a) to f) can be used to manufacture an electrochemical cell that must meet a requirement of high safety of use, for example that must have a good thermal stability and that must withstand loads under a high current. Such requirements are encountered, for example, in railway applications. The lithium-manganese-nickel oxide spinel coated with one of the oxides a) to f) can advantageously be combined with an anode whose active material comprises a lithiated titanium oxide of the Li₄Ti₅O₁₂ type. Indeed, lithiated titanium oxides of the Li₄Ti₅O₂ type support a load under a high current.

A method making it possible to carry out the coating of the oxide f) around the particles of the lithium-manganese-nickel oxide LMNO spinel is described in the following.

In a first step a), an organic or aqueous solution containing titanium ions is prepared by dissolving a titanium precursor. This precursor can be titanium isopropionate which is dissolved in alcohol, such as ethanol.

In a second step b), a lithium salt or an organic compound containing lithium and at least one doping compound chosen from the group consisting of a sodium salt, an organic compound containing sodium, a potassium salt, an organic compound containing potassium, a magnesium salt, an organic compound containing magnesium, a fluorine salt and an organic compound containing fluorine, is dissolved in the solution obtained in step a). The lithium, sodium and potassium can be provided in the form of an acetate, a nitrate, a hydroxide or a sulphate. Preferably, it is an acetate. The fluorine can be supplied in the form of fluoride LiF. Said at least one doping compound is chosen according to the nature of the substituent(s) to be incorporated into the lithiated titanium oxide. If it is desired to substitute both a part of the lithium by one of the elements Na, K or Mg and a part of the oxygen by fluorine, it is possible to use, for example, a mixture of acetates of one or more of the Na, K or Mg elements and lithium fluoride.

In a third step c), LMNO particles are dispersed in the solution of step b).

In a fourth step d), the dispersion is dried. This drying step leads to LMNO particles at least partially coated with a coating comprising the titanium precursor compound, the lithium salt or the organic compound containing lithium and said at least one doping compound. The drying step can be carried out by spray-drying or by evaporation. Spray-drying is a technique which makes it possible to obtain a dry powder from a liquid or a suspension. It consists in spraying a liquid into fine droplets which will then be contacted with a current of hot air in order to evaporate the solvent(s) and thus obtain a powder. Spray-drying has the advantage of leading to a coating of particularly homogeneous thickness.

It is also possible to deposit the coating by the atomic layer deposition technique (ALD). The principle consists in exposing a surface successively to different chemical precursors in order to obtain ultra-thin layers.

In a fifth step e), the particles are subjected to a heat treatment. The heat treatment can be carried out via an oven or a heated nozzle. The heat treatment step can take place at a temperature of at least 700° C. or at least 750° C. or at least 800° C., or at least 850° C. Preferably, the heat treatment step lasts about 2 hours at about 800° C. This heat treatment has the effect of substituting part of the lithium with sodium and/or potassium and/or magnesium and of substituting part of the oxygen with fluorine, if necessary. A coating of a compound of formula Liₓ₋ₐM′ₐTi_{y-b}M″_{b}O_{4-c-d}F_{c} is obtained around the LMNO particles.

A method for producing an ink comprising the LMNO particles coated with lithiated titanium oxide comprises the following steps:
a) a gel is produced by dispersing a binder in an aqueous solution. The binder can be polyacrylic acid, a cellulosic compound such as carboxymethylcellulose, a mixture of carboxymethylcellulose with rubber based on styrene and butadiene;
b) a good electronic conductor compound, such as carbon black, is added to the gel;
c) the LMNO particles coated with lithiated titanium oxide are added to the gel to obtain an ink;
d) at least one face of a current collector is coated with ink to obtain a cathode;
e) the cathode is dried at 80° C. for approximately 10 to 20 minutes.

### EXAMPLES

Various active materials were prepared. Their compositions are shown in Table 1.

TABLE 1

| | uncoated | LMNO coated | LMNO coated with | LMNO coated with |
|---|---|---|---|---|
| | LMNO* | with Li₄Ti₅O₁₂* | Li_{3.98}Na_{0.01}K_{0.01}Ti₅O₁₂ | Li_{3.98}Na_{0.01}K_{0.01}Ti₅O_{11.825}F_{0.175} |
| | (A) | (B) | (C) | (D) |
| Water | 205 | 94 | 45 | 58 |
| content | | | | |
| (ppm) after | | | | |
| drying the | | | | |
| active | | | | |
| material | | | | |

*not part of the invention

The various active materials were immersed in water for several hours. Then, they were dried for 8 hours under vacuum at a temperature of 120° C. The residual water content was then measured by the Karl Fisher method. Compositions C and D according to the invention show a reduction in the water content by a factor of approximately 4.5 compared to the composition A and by a factor of approximately 2 compared to the composition B. The comparison of the results obtained on the compositions C and D with that obtained on the composition B shows that the substitution of a part of the lithium by sodium and potassium and the substitution of a part of the oxygen by fluorine makes it possible to reduce the affinity of LMNO particles for water.

The lower affinity for water of the LMNO particles coated with lithiated titanium oxide is also manifested by better adhesion of the ink to the electrode. The electrode coated with an ink in which the LMNO particles are not covered with lithiated titanium oxide adheres less to the current collector. This can be explained by an affinity of the binder with the residual water contained in the ink. This affinity of the binder for the residual water decreases the adhesion of the ink to the current collector.

1. A compound of formula LiₓMn_{2-y-z}Ni_{y}M_{z}O_{4-d-c}F_{c} (LMNO) where M is one or more elements chosen from the group consisting of B, Mg, Al, Si, Ca, Ti, V, Cr, Fe, Co, Cu, Zn, Y, Zr, Nb, Ru, W and Mo; and 1≤x≤1.4; 0<y≤0.6; 0≤z≤0.2; 0≤d≤1; 0≤c≤1 and the surface of which is at least partially covered with a coating of a second compound chosen from the group consisting of:
a) Liₓ₋ₐM′ₐSi_{y-b}M″_{b}O_{x/2+2y-c-d}F_{c} with 0≤x≤5; 0≤a≤2; 0≤y≤5; 0≤b<y; 0≤c≤2; 0≤d≤2
where M′ is one or more elements chosen from the group consisting of Na, Mg and K;
M″ is one or more elements chosen from the group consisting of B, Mo, Mn, Ce, Sn, Zr, W, V, Ta, Sb, Nb, Ru, Ag, Fe, Co, Ni, Zn, Al, Cr, La, Pr, Bi, Sc, Sm, Gd, Y and Eu;
a and c not being simultaneously zero;
b) Liₓ₋ₐM′ₐNb_{y}Sn_{z}M″_{b}O_{x/2+5y/2+2z-c-d}F_{c} with 0≤x≤3; 0≤a≤3; 0≤y≤1; 0≤z≤1; 0≤b<y+z; 0≤c≤2; 0≤d≤1; b+y+z=1 where
M′ is one or more elements chosen from the group consisting of Na, Mg and K;
M″ is one or more elements chosen from the group consisting of B, Mo, Mn, Ce, Zr, Si, W, V, Ta, Sb, Ru, Ag, Fe, Co, Ni, Zn, Al, Cr, La, Pr, Bi, Sc, Sm, Gd, Y and Eu;
a and c not being simultaneously zero;
c) Nb_{2-b}M″_{b}O_{5-c-d}F_{c} with 0≤b<2; 0<c≤2.5; 0≤d≤2 where
M″ is one or more elements chosen from the group consisting of B, Mo, Mn, Ce, Sn, Zr, Si, W, V, Ta, Sb, Ru, Ag, Fe, Co, Ni, Zn, Al, Cr, La, Pr, Bi, Sc, Sm, Gd, Y and Eu;
d) Liₓ₋ₐM′ₐAl_{2-b}M″_{b}O_{x/2+3-c-d}F_{c} with 0≤x≤3, 0≤a≤1; 0≤b<2; 0≤c≤2.5; 0≤d≤2 where M′ is one or more elements chosen from the group consisting of Na, Mg and K;
M″ is one or more elements chosen from the group consisting of B, Mo, Mn, Ce, Sn, Zr, Si, W, V, Ta, Sb, Nb, Ru, Ag, Fe, Co, Ni, Zn, Cr, La, Pr, Bi, Sc, Sm, Gd, Y and Eu;
a and c not being simultaneously zero;
e) Zr_{1-b}M″_{b}O_{2-c-d}F_{c} with 0≤b<1; 0<c≤1; 0≤d≤1 and M″ is one or more elements chosen from the group consisting of B, Mo, Mn, Ce, Sn, Si, W, V, Ta, Sb, Nb, Ru, Ag, Fe, Co, Ni, Zn, Al, Cr, La, Pr, Bi, Sc, Sm, Gd, Y and Eu; and
f) Liₓ₋ₐM′ₐTi_{y-b}M″_{b}O_{4-c-d}F_{c} in which 0<x≤3; 0≤a≤1; 1≤y≤2.5; 0≤b≤1; 0≤c≤2 and −2.5≤d<2.5; a and c not being simultaneously zero;
M′ is one or more elements chosen from the group consisting of Na, Mg and K;
M″ is one or more elements chosen from the group consisting of B, Mo, Mn, Ce, Sn, Zr, Si, W, V, Ta, Sb, Nb, Ru, Ag, Fe, Co, Ni, Zn, Al, Cr, La, Pr, Bi, Sc, Sm, Gd, Y and Eu.

2. The compound according to claim 1, wherein in the compound of formula f) Liₓ₋ₐM′ₐTi_{y-b}M″_{b}O_{4-c-d}F_{c}; x=4/3; 0≤a≤1; y=5/3; b=0; 0≤c≤2 and d=0; a and c not being simultaneously zero.

3. The compound according to claim 2, wherein 0<a≤0.2 and c=0.

4. The compound according to claim 2, wherein a=0 and 0<c≤0.2.

5. The compound according to claim 2, wherein 0<a≤0.01 and 0<c≤0.1.

6. The compound according to claim 1, wherein 1≤x≤1.4; 0<y≤0.6; z=0 and d=0 in the formula LiₓMn_{2-y-z}Ni_{y}M_{z}O_{4-d} (LMNO).

7. An electrode comprising the compound according to claim 1 and a binder dispersible in an aqueous medium.

8. The electrode comprising a current collector support and the compound according to claim 1.

9. A lithium-ion electrochemical cell comprising at least one cathode which is an electrode according to claim 7.

10. A method for preparing a compound according to claim 1, when the second compound has the formula Liₓ₋ₐM′ₐTi_{y-b}M″_{b}O_{4-c-d}F_{c}, the method comprising the steps of:
a) providing an organic or aqueous solution containing titanium ions;
b) dissolving in the solution of step a) a lithium salt or an organic compound containing lithium and at least one doping compound chosen from the group consisting of a sodium salt, an organic compound containing sodium, a potassium salt, an organic compound containing potassium, a magnesium salt, an organic compound containing magnesium, a fluorine salt, and an organic compound containing fluorine;
c) dispersing a powder of the compound of formula LiₓMn_{2-y-z}Ni_{y}M_{z}O_{4-d} in the solution of step b);
d) drying the dispersion to obtain particles of the compound of formula LiₓMn_{2-y-z}Ni_{y}M_{z}O_{4-d} at least partially coated with the lithium salt or the organic compound containing lithium, a titanium compound and said at least one doping compound of step b);
e) heat treating the particles of step d) to obtain a coating of the second compound of formula Liₓ₋ₐM′ₐTi_{y-b}M″_{b}O_{4-c-d}F_{c}.

11. The method for manufacturing the electrode according to claim 7, comprising the steps of:
a) dispersing at least one binder in water;
b) dispersing the compound in the dispersion of step a);
c) optionally adding an electronically conductive compound to obtain an ink, steps b) and c) possibly being reversed;
d) depositing the ink on a current collector support to form an electrode;
b) drying the electrode.
